(19) United States
(12) Patent Application Publication
(10) Pub. No.: US 2015/0322706 A1
(43) Pub. Date: Nov. 12, 2015

(54) WINDOW REGULATOR

(71) Applicant: SHIROKI CORPORATION, Fujisawa-shi, Kanagawa (JP)

(72) Inventors: Kenji YAMAMOTO, Kanagawa (JP); Yousuke TSUCHIMOTO, Kanagawa (JP)

(21) Appl. No.: 14/651,265

(22) PCT Filed: Nov. 27, 2013
(86) PCT No.: PCT/JP2013/081840

§ 371 Date: Jun. 11, 2015

(30) Foreign Application Priority Data
Dec. 12, 2012 (JP) 2012-270960

(51) Int. Cl. E05F 15/689; B60J 1/17; B60J 1/18; E05F 11/48

(52) U.S. Cl. CPC E05F 15/689; E05F 11/488; B60J 1/17; B60J 1/1861; B60J 1/1892

(57) ABSTRACT

A window regulator prevents a compressing force from acting on a plastic panel to achieve a reduction, in thickness (miniaturization) of the plastic panel.

Between the casing 32 of each of the pair of pulley assemblies 30b and 30c and the associated fit-in recessed portion 20b or 20c, a movement limit portion which limits movement of the casing 32 relative to the plastic panel 10 toward the far side of the associated fit-in recessed portion 20b or 20c from the motor assembly 17 is formed only on the far side of the associated fit-in recessed portion 20b or 20c from the motor assembly 17, which corresponds to the wire winding area of the pulley body (guide member body) 31, out of the near side and the far side of the associated fit-in recessed portion 20b or 20c with respect to the motor assembly 17.

### TECHNICAL FIELD

The present invention relates to a window regulator.

### BACKGROUND ART

In recent years, instead of a window regulator of the related art provided with guide rails which guide slider bases that are fixed to a window glass, upper and lower pairs of pulleys which guide drive wires that extend upwardly and downwardly from the slider bases and which turn back the drive wires, and a motor assembly which includes a drive drum that winds the turned-back drive wires and a motor that drives the drive drum forward and reverse are independently fixed inside a vehicle door; a window regulator has been proposed which achieves reduction in number of components, weight reduction and enhancement of the strength of the window regulator by providing the window regulator as a subassembly by making the pulleys (wire guide members), which are arranged at upper and lower parts of the guide rails, and the motor assembly, which is arranged at a middle position between the upper and lower pairs of pulleys, supported in advance on a plastic panel with which the guide rails are integrally formed. When the plastic panel is fixed to a vehicle door, the pulleys (the plastic panel) are joined onto a door panel (inner panel) via joining bolts which are inserted into shaft holes of the pulleys, and a window glass is joined onto the slider bases.

In the window regulator equipped with such a plastic panel, the pulleys (the wire guide members) are each composed of a pulley assembly (wire guide member assembly) which includes a pulley body (guide member body) and a casing which supports the pulley body in a manner to allow the pulley body to rotate freely, and fit-in recessed portions which house the casings of the pulley assemblies are formed on the plastic panel (Patent Literature 1).

### CITATION LIST

### Patent Literature

Patent Literature 1: A brochure of International Publication 2011/095414

### SUMMARY OF THE INVENTION

### Technical Problem

Forces in directions toward and away from the motor assembly are exerted on the pulley assemblies on the plastic panel via the drive wires that are wound around the pulley bodies. Therefore, the casings of the pair of pulley assemblies in Patent Literature 1 are each provided, on each of the near and far sides of the associated fit-in recessed portion of the plastic panel with respect to the motor assembly, with a movement limit wall which is formed to project and contact the inner wall surface of the associated fit-in recessed portion.

However, according to an analysis by the inventors of the present invention, it has been proven in the above-described structure of the related art that, in a state where the window regulator is fixed to a vehicle door panel with the joining bolts inserted into the shaft holes of the pulley bodies, especially when the window glass reaches the upper dead point or the lower dead point, a relative moving force occurs at each pulley body on the plastic panel via a tension which occurs in the drive wires, and this relative moving force causes a harmful compressing force to be exerted on the plastic panel from the movement limit walls of the casings of the pulley assemblies via the inner wall surfaces of the fit-in recessed portions. The plastic panel is relatively strong against a tensile force even when reduced in thickness (miniaturized); however, the plastic panel is weak against a compressing force, which becomes an obstacle to reducing, as much as possible, the thickness (miniaturization) of the plastic panel.

The present invention has been completed based on the awareness of the above described problems, and an object of the present invention is to achieve a window regulator which can prevent the compressing force from acting on the plastic panel to thereby make it possible to achieve reduction in thickness (miniaturization) of the plastic panel as much as possible.

### Solution to Problem

The present invention has been accomplished based on the finding that the compressing force can be prevented from acting on the plastic panel if the movement limit wall, which is conventionally formed on each of the near and far sides of each fit-in recessed portion with respect to the motor assembly on the plastic panel, is formed only on the far side.

The window regulator according to the present invention is provided, including a guide rail which guides a slider base fixed to a window glass; a drive wire which extends upwardly and downwardly from the slider base; an upper and lower pair of wire guide members which guide the drive wire, which extends upwardly and downwardly, and turns back the drive wire; and a motor assembly which is positioned between the pair of wire guide members and includes a drive drum which winds the drive wire that is turned back by the upper and lower pair of wire guide members, and a motor which drives the drive drum forward and reverse. The guide rail is formed on a plastic panel, the pair of wire guide members and the motor assembly are supported on the plastic panel, and fixing members which are inserted into shaft holes of the pair of wire guide members are fixed to a vehicle door panel. Each of the pair of wire guide members includes a wire guide member assembly which includes a guide member body and a casing that supports the guide member body. A pair of fit-in recessed portions which house the casings of the pair of wire guide assemblies are formed on the plastic panel. Each of the guide member bodies of the pair of wire guide member assemblies is provided, on a far side of the fit-in recessed portion from the motor assembly, with a wire winding area on which the drive wire is wound. Between the casing of each of the pair of wire guide members and an associated one of the pair of fit-in recessed portions, a movement limit portion which limits movement of the casing relative to the plastic panel toward the far side of the fit-in recessed portion from the motor assembly is formed only on the far side of the fit-in recessed portion from the motor assembly, which corresponds to the wire winding area of the guide member body, out of a near side and the far side of the fit-in recessed portion with respect to the motor assembly.

More specifically, the movement limit portion can include a movement limit wall which is formed on the casing to stand out therefrom, and an inner wall surface of associated one of the pair of fit-in recessed portions which comes in contact with the movement limit wall.

It is desirable for the movement limit wall of the casing and the inner wall surface of the fit-in recessed portion to be in contact with each other while being opposed in substantially parallel with each other.

The guide rail includes a pair of guide rails which are spaced from each other at forward and rearward positions of the plastic panel relative to forward and rearward directions of a vehicle. The slider base includes a pair of slider bases which are guided by the pair of guide rails, respectively. The window regulator is a double-guided type in which the upper and lower pair of wire guide members are supported by an upper part of one of the pair of guide rails and a lower part of the other of the pair of guide rails, respectively.

### Advantageous Effects of the Invention

According to the invention claimed in claim 1, even especially when the window glass reaches the upper dead point or the lower dead point to thereby cause a relative moving force at each pulley body (guide member body) on the plastic panel via a tension which occurs in the drive wire, this relative moving force is received by the pair of movement limit portions that are formed between the casings of the pair of assemblies (wire guide member assemblies) and the corresponding fit-in recessed portions, which makes it possible to prevent a harmful compressing force from acting on the plastic panel.

According to the inventions claimed in claims 2 and 3, an improvement in strength of the movement limit portions enables the movement limit portions to securely receive the relative moving force that occurs at each pulley body on the plastic panel, thus making it possible to more reliably prevent a harmful compressing force from acting on the plastic panel.

According to the invention claimed in claim 4, the window regulator according to the present invention is ideal because it can be applied to a double-guided type window regulator.

### BRIEF DESCRIPTION OF THE DRAWINGS

FIG. 1 is a diagram showing a window regulator according to the present invention, viewed from the vehicle exterior side;

FIG. 2 is a diagram showing the window regulator according to the present invention, viewed from the vehicle interior side;

FIG. 3 is a diagram showing the window regulator according to the present invention, viewed in the longitudinal direction of the vehicle;

FIG. 4 is a cross sectional view taken along the IV-IV line shown in FIG. 1;

FIG. 5 is a cross sectional view taken along the V-V line shown in FIG. 1;

FIG. 6 is an enlarged perspective view showing the fit-in structure of each pulley assembly to the associated fit-in recessed portion;

FIG. 7 is an enlarged perspective view, which corresponds to that of FIG. 6, in which a pulley body and a nut member are removed from the pulley assembly to expose the movement limit walls of the casing; and

FIGS. 8(A), 8(B) and 8(C) are diagrams stepwisely showing how relative moving forces that occur at the pulley bodies travel to the plastic panel when a window glass reaches the bottom dead point to thereby cause these relative moving forces.

### DESCRIPTION OF EMBODIMENT

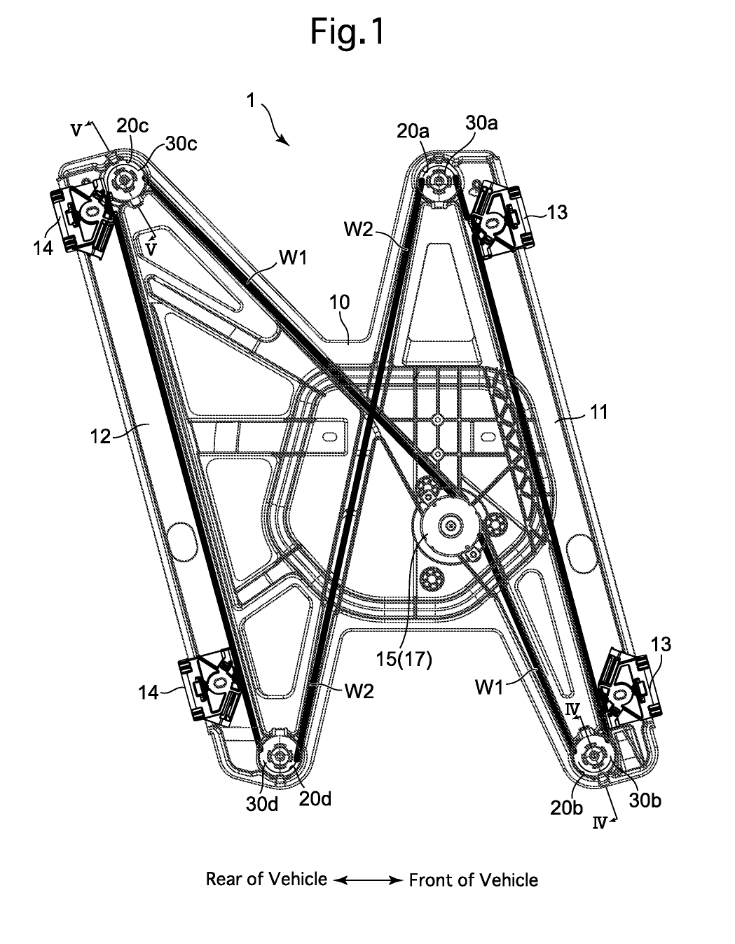

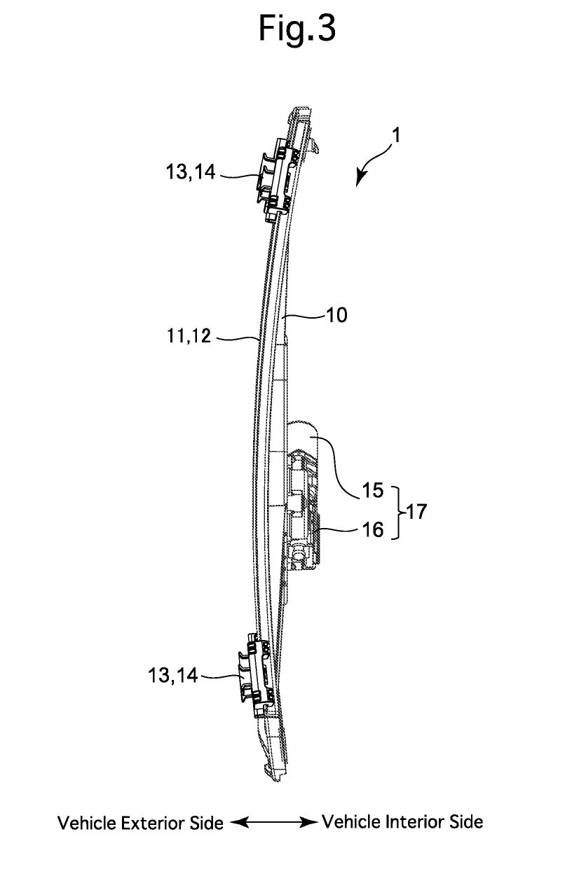

FIGS. 1 through 3 show the structure of a window regulator 1 according to the present invention. In these drawings, the window regulator 1 is illustrated in a subassembled state before it is installed in a vehicle door. Directions described in the following description are defined based on the directions of the arrows shown in the drawings.

The window regulator 1 is provided with a unitarily-formed plastic (resin) panel 10 which is H-shaped, as viewed macroscopically in the widthwise direction of the vehicle (from the vehicle exterior side or the vehicle interior side), and which is slightly curved toward the vehicle exterior side from the vehicle interior side as viewed in the longitudinal direction of the vehicle. The plastic panel 10 is integrally provided, on the vehicle-front side and the vehicle-rear side, with a straight guide rail 11 and a straight guide rail 12, respectively, which extend parallel to each other in the upward/downward direction. A slider base 13 and a slider base 14 to which a window glass (not shown) is fixed are supported on the guide rail 11 and the guide rail 12, respectively, to be upwardly and downwardly movable.

Fit-in recessed portions 20a, 20b, 20c and 20d are formed integral with the plastic panel 10 so that the fit-in recessed portions 20a and 20b are positioned at upper and lower parts of the guide rail 11, respectively, and the fit-in recessed portions 20c and 20d are positioned at upper and lower parts of the guide rail 12, respectively. Pulley assemblies (pulleys/wire guide members/wire guide member assemblies) 30a, 30b, 30c and 30d are fitted into and supported by the fit-in recessed portions 20a, 20b, 20c and 20d, respectively. The pulley assemblies 30b and 30c are components which correspond to “the pair of wire guide members (the pair of wire guide member assemblies)” recited in the claims and the fit-in recessed portions 20b and 20c are components which correspond to “the pair of fit-in recessed portions” recited in the claims.

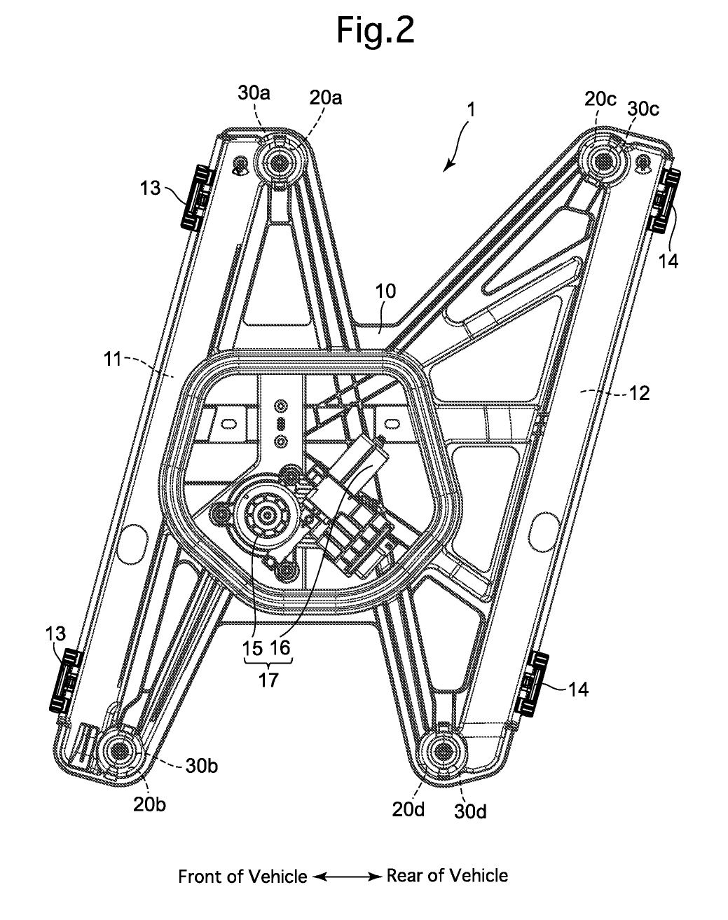

A motor assembly 17 which includes a drive drum 15 and a motor unit 16, which drives the drive drum 15 to rotate in the forward and reverse directions, are supported by the plastic panel 10 at a central part thereof. The motor assembly 17 is positioned at an intermediate position between the pulley assembly 30b and the pulley assembly 30c. A drive wire W1 which is wound around the drive drum 15 extends upwardly and downwardly, connected at one downwardly-extending end thereof to the slider base 13 after being turned back from the downward direction to the upward direction by the pulley assembly 30b and connected at the other upward-extending end thereof to the slider base 14 after being turned back from the upward direction to the downward direction by the pulley assembly 30c. Namely, the drive drum 15 winds the drive wire W1 which has been turned back by the pulley assembly 30b and the pulley assembly 30c. In addition, the slider base 13 and the slider base 14 are connected to each other via a drive wire W2 (a separate member from the drive wire W1) which is vertically turned back by the pulley assembly 30a and the pulley assembly 30d. Accordingly, driving the drive drum 15 by the motor unit 16 so that the drive drum 15 rotates forwardly and in reverse causes the slider bases 13 and 14 (the window glass) to move upwardly and downwardly while being guided by the guide rails 11 and 12, respectively. In FIGS. 1 and 2, the top dead points of the slider bases 13 and 14, at which the window glass (not shown) is fully closed, and the bottom dead points of the slider bases 13 and 14, at which the window glass (not shown) is fully open, in a state where the window regulator 1 is incorporated in a vehicle door are both illustrated.

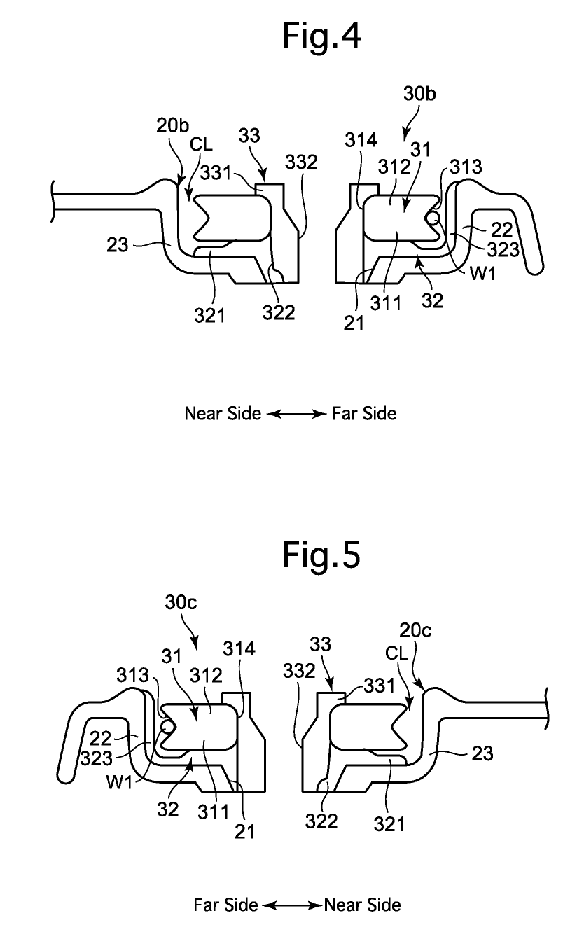

The structure of the pair of pulley assemblies 30b and 30c and the pair of fit-in recessed portions 20b and 20c will be hereinafter discussed in detail with reference to FIGS. 4 through 7. The fit-in structure between the pulley assembly 30b and the fit-in recessed portion 20b and the fit-in structure between the pulley assembly 30c and the fit-in recessed portion 20c are mutually identical and symmetrical with respect to the center of the motor assembly 17, and accordingly, components of the pair of pulley assemblies 30b and 30c are designated with common reference numerals and the pair of fit-in recessed portions 20b and 20c are designated with common reference numerals in FIGS. 4 through 7.

The pair of fit-in recessed portions 20b and 20c are substantially circular in shape in a plan view, and a through-hole 21 is formed in a central part of each fit-in recessed portion 20b and 20c.

The pair of pulley assemblies 30b and 30c are each provided with a pulley body (guide member body) 31, a casing (pulley bracket) 32 and a nut member 33 which supports the pulley body 31 to the casing 32 in a manner to allow the pulley body 31 to rotate freely.

The pulley body 31 is provided with a base-side flange portion 311 and a top-side flange portion 312 each of which is in the shape of a full-disk, and is further provided with a wire guide groove 313 which is formed between the base-side flange portion 311 and the top-side flange portion 312. The drive wire W1 that is wound around the drive drum 15 and fixed to the slider base 13 and the slider base 14 is wound around the wire guide groove 313. An insertion hole 314 for the nut member 33 to be inserted into is formed in a central part of the pulley body 31. As shown in FIG. 4, the pulley body 31 of the pulley assembly 30b is provided, on the far side of the fit-in recessed portion 20b from the motor assembly 17, with a wire winding area on which the drive wire W1 is wound (an area of the wire guide groove 313 on which the drive wire W1 is wound), while the pulley body 31 of the pulley assembly 30b is provided, on the near side of the fit-in recessed portion 20b to the motor assembly 17, with a wire non-winding area on the drive wire W1 is not wound (an area of the wire guide groove 313 on which the drive wire W1 is not wound). As shown in FIG. 5, the pulley body 31 of the pulley assembly 30c is provided, on the far side of the fit-in recessed portion 20c from the motor assembly 17, with a wire winding area on which the drive wire W1 is wound (an area of the wire guide groove 313 on which the drive wire W1 is wound), while the pulley body 31 of the pulley assembly 30c is provided, on the near side of the fit-in recessed portion 20c to the motor assembly 17, with a wire non-winding area on the drive wire W1 is not wound (an area of the wire guide groove 313 on which the drive wire W1 is not wound).

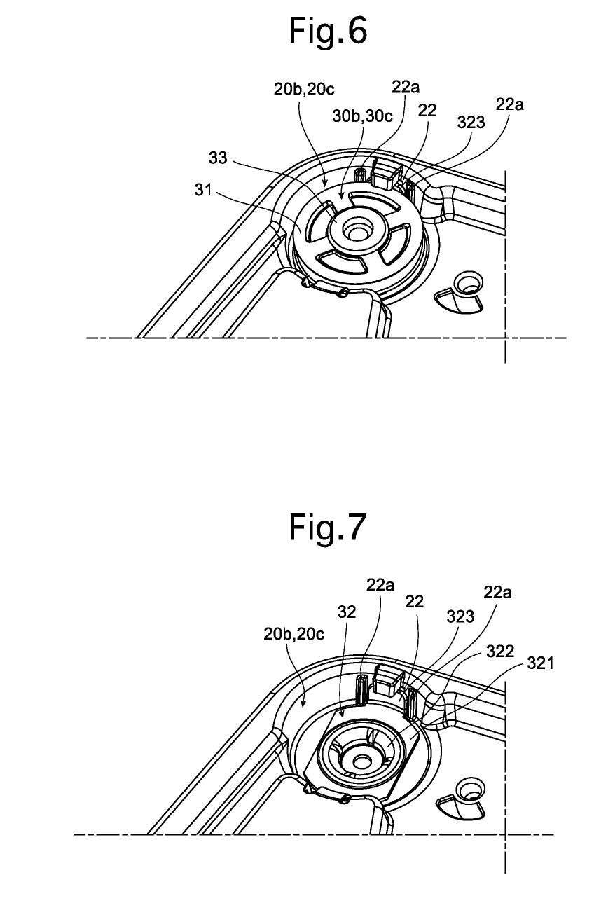

The casing 32 is provided with a pulley support surface 321 which supports the base-side flange portion 311 of the pulley body 31, and a fit-in cylindrical portion 322 which extends downward from a central part of the pulley support surface 321 to be fitted into the through-hole 21 of the associated fit-in recessed portion 20b or 20c. A movement limit wall (movement limit portion) 323 is formed on the pulley support surface 321 to stand out from a portion of the pulley support surface 321 on the far side from the motor assembly 17 (this portion corresponds to the wire winding area of the pulley body 31) and is in contact with an inner wall surface (the movement limit portion) 22 of the associated fit-in recessed portion 20b or 20c on the far side from the motor assembly 17 in a mutually facing state. As shown in FIGS. 6 and 7, the inner wall surfaces 22 of the pair of fit-in recessed portions 20b and 20c are each provided with a guide projection 22a which guides the movement limit wall 323 of the casing 32 of the associated pulley assembly 30b or 30c to define the circumferential position of the movement limit wall 323. On the other hand, the movement limit wall 323 is not provided on the near side of the pulley support surface 321 relative to the motor assembly 17 (this portion corresponds to the wire-non-winding area of the pulley body 31); a clearance CL is formed between an inner wall surface 23 of the fit-in recessed portion 20b (which is formed on the near side of the fit-in recessed portion 20b relative to the motor assembly 17) and the associated casing 32, and a clearance CL is formed between the casing 32 and an inner wall surface 23 of the fit-in recessed portion 20c (which is formed on the near side of the fit-in recessed portion 20c relative to the motor assembly 17) and the associated casing 32. Accordingly, between the pulley assembly 30b (the casing 32 thereof) and the fit-in recessed portion 20b, a movement limit portion (the movement limit wall 323 and the inner wall surface 22) which limits movement of the casing 32 relative to the plastic panel 10 toward the far side of the fit-in recessed portion 20b from the motor assembly 17 is formed on only the far side of the fit-in recessed portion 20b from the motor assembly 17, which corresponds to the wire winding area of the pulley body 31, out of the near and far sides of the fit-in recessed portion 20b with respect to the motor assembly 17 (see FIG. 4). Likewise, between the pulley assembly 30c (the casing 32 thereof) and the fit-in recessed portion 20c, a movement limit portion (the movement limit wall 323 and the inner wall surface 22) which limits movement of the casing 32 relative to the plastic panel 10 toward the far side of the fit-in recessed portion 20c from the motor assembly 17 is formed on only the far side of the fit-in recessed portion 20c from the motor assembly 17, which corresponds to the wire winding area of the pulley body 31, out of the near and far sides of the fit-in recessed portion 20c with respect to the motor assembly 17 (see FIG. 5).

The nut member 33 is formed as a shaft member which is inserted into the insertion hole 314 of the pulley body 31 and fixed to the lower end of the fit-in cylindrical portion 322 of the casing 32 by swaging. A flange portion 331 which is in contact with the top-side flange portion 312 of the pulley body 31 is formed at the upper end of the nut member 33. A bolt insertion hole 332 into which a joining bolt (fixing member) for incorporating the window regulator 1 in a subassembled state in a vehicle door is inserted is formed in a central part of the nut member 33.

The window regulator 1 that is constructed as described above is assembled in a manner which will be discussed hereinafter. First, the slider base 13 and the slider base 14 are supported by the guide rail 11 and the guide rail 12 of the plastic panel 10 to be upwardly and downwardly movable. Subsequently, the drive wire W1 which is fixed at one end and the other end thereof to the slider base 13 and the slider base 14, respectively, and a middle part of which is wound around the drive drum 15 is wound around the pulley bodies 31 of the pulley assemblies 30b and 30c, and the pulley assembly 30b and the pulley assembly 30c are fitted into the fit-in recessed portion 20b and the fit-in recessed portion 20c of the plastic panel 10, respectively. This fit-in operation is performed with the limit movement walls 323 of the casings 32 of the pair of pulley assemblies 30b and 30c aligned with the guide projections 22a of the inner wall surfaces 22 of the pair of fit-in recessed portions 20b and 20c, respectively. At the same time, the drive wire W2 which is fixed at one end and the other end thereof to the slider base 13 and the slider base 14, respectively, is wound around the pulley bodies 31 of the pulley assemblies 30a and 30d, and the pulley assembly 30a and the pulley assembly 30d are fitted into the fit-in recessed portion 20a and the fit-in recessed portion 20d of the plastic panel 10, respectively. The drive wire W1 and the drive wire W2 are fixed to the slider base 13 and the slider base 14, respectively, so that a tensile load is imposed on the drive wire W1 and the drive wire W2 in this fitted state. With the above described operations, the window regulator 1 in a subassembled state before it is installed in a vehicle door is completed.

The window regulator 1 configured as a subassembly as described above is incorporated, as the window regulator 1 in a completed state, in a vehicle door by joining the plastic panel 10 to a vehicle door panel (inner panel) by joining bolts (not shown) which are inserted into the bolt insertion holes 332 of the nut members 33 and, at the same time, by joining a window glass (not shown) to the slider base 13 and the slider base 14.

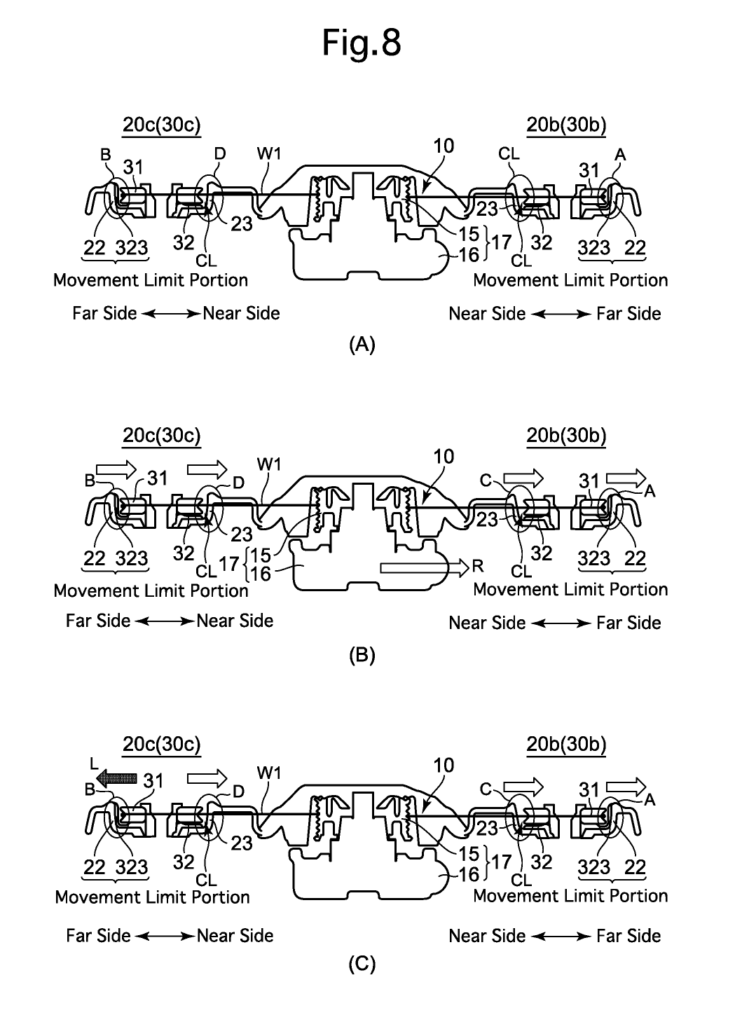

In the window regulator 1 in a completed state, how relative moving forces that occur at the pulley bodies travel to the plastic panel 10 when the window glass (not shown) reaches the bottom dead point to thereby cause these relative moving forces will be hereinafter discussed in detail with reference to FIGS. 8(A) through 8(C).

As shown in FIG. 8(A), in a state where the window glass is neither moving upwardly nor downwardly and no relative moving force has occurred at either of the pair of pulley assemblies 30b and 30c on the plastic panel 10, the movement limit walls (movement limit portions) 323 of the pulley assemblies 30b and 30c are in contact with the inner wall surfaces (movement limit surfaces) 22 of the fit-in recessed portions 20b and 20c on the far side of the fit-in recessed portions 20b and 20c from the motor assembly 17, respectively, in a mutually facing state. On the other hand, the clearance CL is formed between the inner wall surface 23 of the fit-in recessed portion 20b, which is formed on the near side of the fit-in recessed portion 20b to the motor assembly 17 and the associated casing 32, and the clearance CL is formed between the inner wall surface 23 of the fit-in recessed portion 20c, which is formed on the near side of the fit-in recessed portion 20c to the motor assembly 17 and the associated casing 32. In the following descriptions, a portion of the inner wall surface 22 of the fit-in recessed portion 20b of the plastic panel 10 which is in contact with the movement limit wall 323 of the pulley assembly 30b is designated by “area A”, a portion of the inner wall surface 22 of the fit-in recessed portion 20c of the plastic panel 10 which is in contact with the movement limit wall 323 of the pulley assembly 30c is designated by “area B”, a portion of the plastic panel 10 between the inner wall surface 23 of the fit-in recessed portion 20b and the casing 32 of the pulley assembly 30b in which the clearance CL is formed is designated by “area C”, and a portion of the plastic panel 10 between the inner wall surface 23 of the fit-in recessed portion 20c and the casing 32 of the pulley assembly 30c in which the clearance CL is formed is designated by “area D”.

As shown in FIG. 8(B), upon the window glass moving down to the lower dead point, a force which urges the motor assembly 17 that is supported by the plastic panel 10 to move toward the pulley assembly 20b is exerted on the motor assembly 17 by the force imposed on the drive wires W1 and W2, which causes the entire plastic panel 10 to attempt to move toward the pulley assembly 20b. At this time, the moving force of the pulley assembly 30c is not transmitted to the plastic panel 10 because the clearance CL is formed in the area D between the inner wall surface 23 of the fit-in recessed portion 20c and the casing 32 of the pulley assembly 30c.

On the other hand, when a force which urges the plastic panel 10 to move toward the pulley assembly 20b is exerted on the entire plastic panel 10, since the inner wall surface 22 of the fit-in recessed portion 20b is in contact with the movement limit wall 323 of the pulley assembly 30b in the area A, a reaction force acts on the pulley assembly 30b at this contact portion, which causes a relative moving force in a direction to make the plastic panel 10 and the pulley assembly 30c come in contact with each other in the area B as shown in FIG. 8(C) (the arrow L in FIG. 8(C)). As a result, a relative moving force in a direction (the leftward direction with respect to FIG. 8(C)) to make the plastic panel 10 come in contact with the pulley assembly 30c acts on the plastic panel 10 in the area B, and a relative moving force in a direction (the rightward direction with respect to FIG. 8C) to make the plastic panel 10 come in contact with the pulley assembly 30b acts on the plastic panel 10 in the area A, the area C and the area D. Namely, the relative moving forces of the pair of pulley assemblies 30b and 30c on the plastic panel 10 acts on the plastic panel 10 as a tensile force, so that no harmful compressing force acts on the plastic panel 10.

In FIGS. 8(A) through 8(C), the case where the window glass (not shown) reaches the lower dead point has been illustrated; however, even in the case where the window glass (not shown) reaches the upper dead point, the relative moving forces of the pair of pulley assemblies 30b and 30c on the plastic panel 10 are received by the pair of movement limit portions (the movement limit walls 323 and the inner wall surfaces 22) and act on the plastic panel 10 as a tensile force in a similar manner, so that no harmful compressing force acts on the plastic panel 10.

As can be understood from the above, in the present embodiment of the window regulator 1, between the pulley assembly (wire guide member assembly) 30b and the fit-in recessed portion 20b, a movement limit portion (the movement limit wall 323 and the inner wall surface 22) which limits movement of the associated casing 32 relative to the plastic panel 10 toward the far side of the fit-in recessed portion 20b from the motor assembly 17 is formed on only the far side of the fit-in recessed portion 20b from the motor assembly 17, out of the near and far sides of the fit-in recessed portion 20b with respect to the motor assembly 17; in addition, between the pulley assembly (wire guide member assembly) 30c and the fit-in recessed portion 20c, a movement limit portion (the movement limit wall 323 and the inner wall surface 22) which limits movement of the associated casing 32 relative to the plastic panel 10 toward the far side of the fit-in recessed portion 20c from the motor assembly 17 is formed on only the far side of the fit-in recessed portion 20c from the motor assembly 17, out of the near and far sides of the fit-in recessed portion 20c with respect to the motor assembly 17, which makes it possible to prevent a compressing force from acting on the plastic panel 10 to thereby make it possible to achieve a reduction, as much as possible, in thickness (miniaturization) of the plastic panel 10. It is a compressing force (not a tensile force) acting on the plastic panel 10 that causes strength issues when the plastic panel 10 has been reduced, as much as possible, in thickness (miniaturized).

In the above illustrated embodiment, a so-called plastic panel type of window regulator 1, in which the pair of pulley assemblies 30b and 30c and the motor assembly 17 are supported on the plastic panel 10, with which the guide rails 11 and 12 are formed integral, has been illustrated by way of example. However, the present invention can also be applied similarly to a window regulator using a panel member made of metal (e.g., iron) instead of a plastic panel.

In the above illustrated embodiment, the case where the pair of pulley assemblies 30b and 30c are each provided with the pulley body 31 and the casing 32 that supports the pulley body 31 in a manner to allow the pulley body 31 to be rotatable has been illustrated by way of example. However, the present invention can also be applied similarly to a window regulator in the case where it is equipped with wire guide member assemblies as a pair of wire guide member assemblies as a substitute for the pair of pulley assemblies 30b and 30c, wherein each wire guide member assembly includes a guide member body and a casing which supports the guide member body in a manner to prevent the guide member body from rotating.

In the above illustrated embodiment, the so-called double-guided type of window regulator 1, in which the slider base 13 and the slider base 14 are respectively supported on the guide rail 11 and the guide rail 12, which are arranged at positions relative to the forward and rearward directions of the vehicle, and are upwardly and downwardly movable, has been illustrated by way of example. However, the present invention can also be applied similarly to a single-guided type of window regulator, in which a single slider base is supported on a single guide rail to be upwardly and downwardly movable. In this case, fit-in recessed portions which are formed at upper and lower parts of the guide rail and pulley assemblies (pulleys) which are fitted into the fit-in recessed portions constitute a pair of fit-in recessed portions and a pair of pulley assemblies (a pair of pulleys), respectively.

In the above illustrated embodiment, the case where a movement limit portion is configured by overlaying the movement limit wall 323 of the casing 32 of the pulley assembly 30b and the inner wall surface 22 of the fit-in recessed portion 20b onto each other and overlaying the movement limit wall 323 of the casing 32 of the pulley assembly 30c and the inner wall surface 22 of the fit-in recessed portion 20c onto each other has been illustrated by way of example. However, it is possible to make each movement limit portion out of the inner wall surface 22 of the associated fit-in recessed portion 20b or 20c alone by omitting the movement limit walls 323 of the casings 32 and forming the shape of each inner wall surface 22 so that it is positioned close to the associated casing 32. Namely, in this embodiment, it is advisable to set the clearance between the inner wall surface 22, which is positioned on the far side from the motor assembly 17, and the casing 32 to be smaller than the clearance between the inner wall surface 23, which is positioned on the near side to the motor assembly 17, and the casing 32 in each fit-in recessed portion 20b and 20c.

### INDUSTRIAL APPLICABILITY

The window regulator according to the present invention is advantageously used as a window regulator which moves a window glass of, e.g., a vehicle upwardly and downwardly.

### REFERENCE SIGN LIST

1 Window regulator
10 Plastic panel
11 12 Guide rail
13 14 Slider base
15 Drive drum
16 Motor unit
17 Motor assembly
20a 20b 20c 20d Fit-in recessed portion
20b 20c a pair of fit-in recessed portions
21 Through-hole
22 Inner wall surface (movement limit portion) of the fit-in recessed portion which is positioned on the far side from the motor assembly
22a Guide projection
23 Inner wall surface (movement limit portion) of the fit-in recessed portion which is positioned on the near side to the motor assembly
30a 30b 30c 30d Pulley assembly (pulley/wire guide member/wire guide member assembly)
30b 30c a pair of pulley assemblies (a pair of pulleys/a pair of wire guide members/a pair of wire guide member assemblies)
31 Pulley body (guide member body)
311 Base-side flange portion
312 Top-side flange portion
313 Wire guide groove
314 Insertion hole
32 Casing (pulley bracket)
321 Pulley support surface
322 Fit-in cylindrical portion
323 Movement limit wall (movement limit portion)
33 Nut member
331 Flange portion
332 Bolt insertion hole
CL Clearance
W1 W2 Drive wire

1. A window regulator comprising:
a guide rail which guides a slider base fixed to a window glass;
a drive wire which extends upwardly and downwardly from said slider base;
an upper and lower pair of wire guide members which guide said drive wire, which extends upwardly and downwardly, and turns back said drive wire; and
a motor assembly which is positioned between said pair of wire guide members and includes a drive drum which winds said drive wire that is turned back by said upper and lower pair of wire guide members, and a motor which drives said drive drum forward and reverse,
wherein said guide rail is formed on a plastic panel, said pair of wire guide members and said motor assembly are supported on said plastic panel, and fixing members which are inserted into shaft holes of said pair of wire guide members are fixed to a vehicle door panel,
wherein each of said pair of wire guide members includes a wire guide member assembly which includes a guide member body and a casing that supports said guide member body,
wherein a pair of fit-in recessed portions which house said casings of said pair of wire guide assemblies are formed on said plastic panel,
wherein each of said guide member bodies of said pair of wire guide member assemblies is provided, on a far side of said fit-in recessed portion from said motor assembly, with a wire winding area on which said drive wire is wound, and
wherein, between said casing of each of said pair of wire guide members and an associated one of said pair of fit-in recessed portions, a movement limit portion which limits movement of said casing relative to said plastic panel toward said far side of said fit-in recessed portion from said motor assembly is formed only on said far side of said fit-in recessed portion from said motor assembly, which corresponds to said wire winding area of said guide member body, out of a near side and said far side of said fit-in recessed portion with respect to said motor assembly.

2. The window regulator according to claim 1, wherein said movement limit portion comprises a movement limit wall which is formed on said casing to stand out therefrom, and an inner wall surface of associated one of said pair of fit-in recessed portions which comes in contact with said movement limit wall.

3. The window regulator according to claim 2, wherein said movement limit wall of said casing and said inner wall surface of said fit-in recessed portion are in contact with each other while being opposed in substantially parallel with each other.

4. The window regulator according to claim 1, wherein said guide rail comprises a pair of guide rails which are spaced from each other at forward and rearward positions of said plastic panel relative to forward and rearward directions of a vehicle,
wherein said slider base includes a pair of slider bases which are guided by said pair of guide rails, respectively, and
wherein said window regulator is a double-guided type in which said upper and lower pair of wire guide members are supported by an upper part of one of said pair of guide rails and a lower part of the other of said pair of guide rails, respectively.
